(19) United States
(12) Patent Application Publication
(10) Pub. No.: US 2009/0011131 A1
(43) Pub. Date: Jan. 8, 2009

(54) METHOD FOR TREATING SURFACE OF HEAT DISSIPATING MODULE

(75) Inventors: Yu-Cheng Chou, Taipei (TW); Te-Li Tsai, Taipei (TW); Ming-Feng Tsai, Taipei (TW); Chich-Hua Shen, Taipei (TW); Hsueh-Lung Cheng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei (TW)

(21) Appl. No.: 12/146,475

(22) Filed: Jun. 26, 2008

(30) Foreign Application Priority Data
Jul. 6, 2007 (TW) 96124681

(51) Int. Cl. B05D 3/10; B05D 1/18

(52) U.S. Cl. 427/307; 427/430.1

(57) ABSTRACT

A method for treating the surface of the heat dissipation module is provided. The method includes the following steps. First, a heat dissipation module is provided. Next, a nano-material layer is formed on the surface of the heat dissipation module. Thus, the surface of the heat dissipation module is isolated from air and effectively prevented from being oxidized or polluted.

### CROSS-REFERENCE TO RELATED APPLICATION

This application claims the priority benefit of Taiwan application serial no. 96124681, filed on Jul. 6, 2007. The entirety of the above-mentioned patent application is hereby incorporated by reference herein and made a part of specification.

### BACKGROUND OF THE INVENTION

1. Field of the Invention

The invention relates to a method for treating a surface and, more particularly, to a method for treating the surface of a heat dissipation module.

2. Description of the Related Art

In recent years, with the rapid progress of the computer technology, the operating speed of the computer increases. Then, the heat generation rate of electronic elements in the computer also increases. To prevent the electronic elements in the computer from being overheated and losing effectiveness temporarily or permanently because of the overheating condition, a heat dissipation module is usually provided on the electronic elements to dissipation heat.

However, since the dust is accumulated on the heat dissipation module after a long usage time, and the metal surface of the heat dissipation module is easily oxidized when contacting air, the heat dissipation efficiency of the heat dissipation module is not preferred.

### BRIEF SUMMARY OF THE INVENTION

The invention provides a method for treating the surface of a heat dissipation module, which solves the oxidization problem of the surface of the heat dissipation module.

The invention provides a method for treating the surface of a heat dissipation module, which solves the problem that dust is easily accumulated on the surface of the heat dissipation module.

The invention provides a method for treating the surface of a heat dissipation module. A nano-material layer is formed on the surface of a heat dissipation module to isolate the surface of the heat dissipation module from the air, and then the surface of the heat dissipation module is prevented from being oxidized effectively.

In one embodiment of the invention, the method for forming a nano-material layer includes a plating process.

In one embodiment of the invention, the nano-material layer is coated on the surface of the heat dissipation module.

In one embodiment of the invention, the nano-material layer includes the nano titania powder (TiO₂) or silicon dioxide (SiO₂).

In one embodiment, a surface leveling process is performed on the heat dissipation module before a nano-material layer is formed on the surface of the heat dissipation module.

In one embodiment of the invention, the surface leveling process includes an acid washing process.

In one embodiment of the invention, the acid washing solution includes the dilute sulphuric acid solution.

In one embodiment of the invention, the surface leveling process includes a dip plating method.

In one embodiment of the invention, the dip plating solution includes the nano TiO₂ or SiO₂ dip plating solution.

In one embodiment of the invention, after a nano-material layer is formed on the surface of the heat dissipation module, a nano-material protecting layer is formed on the nano-material layer.

In one embodiment of the invention, after a nano-material layer is formed on the surface of the heat dissipation module, a color material layer is formed on the nano-material layer.

In one embodiment of the invention, the color material layer includes the nano TiO₂ or SiO₂.

In one embodiment of the invention, after the nano-material layer is formed on the surface of the heat dissipation module, an antifouling material layer is formed on the nano-material layer.

In one embodiment of the invention, the antifouling material layer includes the nano TiO₂ or SiO₂.

In one embodiment of the invention, after the nano-material layer is formed on the surface of the heat dissipation module, an antistatic material layer is formed on the nano-material layer.

In one embodiment of the invention, the antistatic material layer includes the nano TiO₂ or SiO₂.

In one embodiment of the invention, the heat dissipation module is an extruded heat sink.

In one embodiment of the invention, the heat dissipation module is a heat dissipation fan.

In the invention, a nano-material layer is formed on the surface of the heat dissipation module to isolate the metal surface of the heat dissipation module from the air, prevent the dust from accumulating on the heat dissipation module and prevent the metal surface being oxidized, so that the heat dissipation module has preferred heat dissipation efficiency.

These and other features, aspects, and advantages of the present invention will become better understood with regard to the following description, appended claims, and accompanying drawings.

### BRIEF DESCRIPTION OF THE DRAWINGS

FIG. 1A and FIG. 1B are schematic diagrams showing the flow path of a method for treating the surface of a heat dissipation module according to an embodiment of the invention.

FIG. 2 is a schematic diagram showing a nano-material protecting layer formed on the nano-material layer shown in FIG. 1B.

FIG. 3 is a schematic diagram showing a color material layer formed the nano-material layer shown in FIG. 1B.

FIG. 4 is a schematic showing a heat dissipation module on which the method for treating a surface is performed according to another embodiment of the invention.

### DETAILED DESCRIPTION OF THE EMBODIMENTS

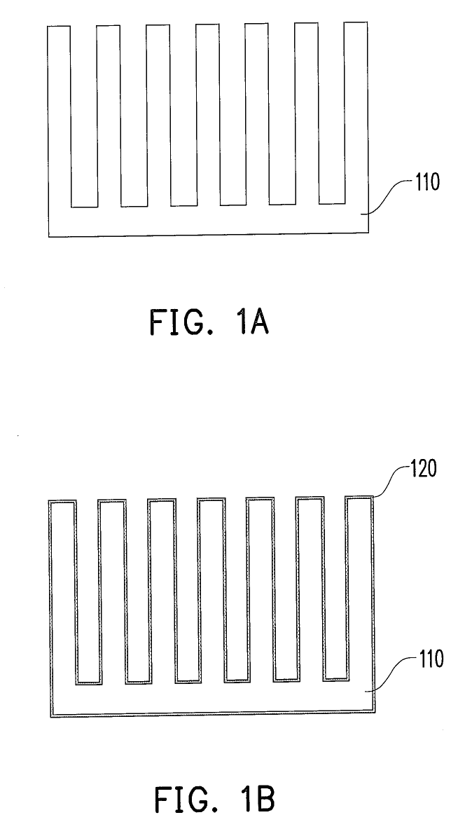

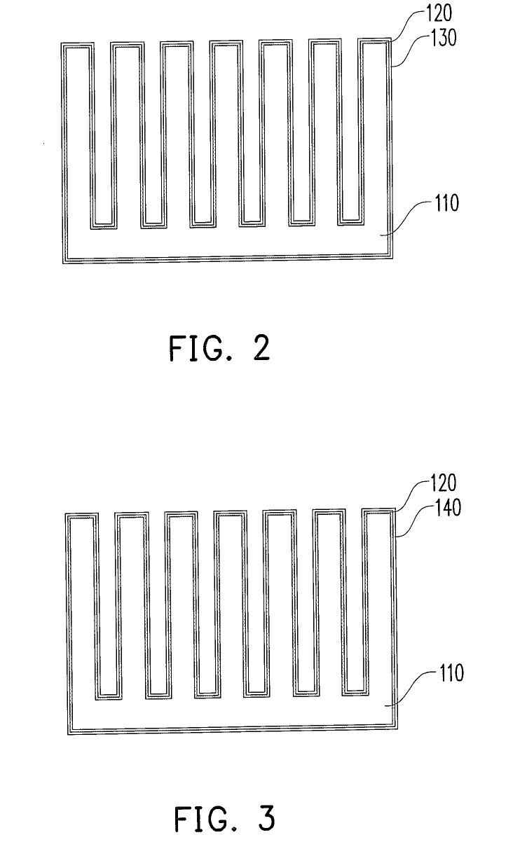

FIG. 1A and FIG. 1B are schematic diagrams showing the flow path of the method for treating the surface of the heat dissipation module according to one embodiment of the invention. As shown in FIG. 1A, a heat dissipation module 110 such as an extruded heat dissipation module is provided. Then, as shown in FIG. 1B, a nano-material layer 120 is formed on the surface of the heat dissipation module 110 to enable the heat dissipation module 110 to have a characteristic of anti-oxidation. The nano-material layer 120 is nano titania powder (TiO₂) or silicon dioxide (SiO₂) or other proper material. The method for treating the surface of the heat dissipation module shown in FIG. 1A and FIG. 1B is described in detail hereinbelow.

In the embodiment, to make the surface of the heat dissipation module 110 has a preferred planeness, a surface leveling process may be performed on the heat dissipation module before the nano-material layer 120 is formed on the surface of the heat dissipation module. The surface leveling process is an acid washing process. The acid washing solution is dilute sulphuric acid solution. In addition, in other embodiment, the heat dissipation module 110 also may be soaked in nano TiO₂ or SiO₂ dip plating solution by a dip plating method to enable the surface of the heat dissipation module to have a preferred planeness. In this way, after the nano-material layer 120 is formed on the surface of the heat dissipation module by a proper method such as a plating process, a coating method or other method, the nano-material layer 120 can fill the minute recess at the surface of the heat dissipation module effectively. Thus, the heat dissipation module has a plane surface.

In the embodiment, the nano-material layer 120 not only can fill the minute recess at the surface of the heat dissipation module effectively to make the heat dissipation module have a preferred planeness. It also can enable the heat dissipation module 110 to have an anti-oxidation and dustproof function. The nano-material layer 120 can effectively isolate the heat dissipation module 110 from the air in the environment via the material characteristic thereof. Then, the metal material of the heat dissipation module 110 is not easily oxidized, dust is not easily accumulated on the surface of the heat dissipation module 110, and the heat dissipation module 110 can keep good heat conduction efficiency.

From the above, to make the nano-material layer 120 provided on the metal surface of the heat dissipation module 110 more effectively and prevent the nano-material layer 120 from being chipped off because of extrinsic factors easily, after the nano-material layer 120 is formed on the surface of the heat dissipation module 110, a nano-material protecting layer 130 is formed on the nano-material layer 120 (FIG. 2 is a schematic diagram showing a nano-material protecting layer formed on the nano-material layer shown in FIG. 1B). The nano-material protecting layer 130 is, for example, a film layer with the SiO₂ as the interface on which Al₂O₃ and nano TiO₂ are formed. Then, the heat dissipation module 110 has characteristics of anti-abrasion, anti-acid and anti-alkali.

In addition, after the nano-material layer 120 is formed on the surface of the heat dissipation module 110, a color material layer 140 is formed on the nano-material layer 120 (FIG. 3 is a schematic diagram showing a color material layer formed on the nano-material layer shown in FIG. 1B). Then, the heat dissipation module 110 has a preferred appearance. In addition, an antifouling material layer or an antistatic material layer also may be formed on the nano-material layer 120. Then, the heat dissipation module 110 can be used in various environments. The antifouling material layer is, for example, formed on the nano-material layer 120 by the plasma activation technology and vacuum coating method. The antistatic material layer provides the heat dissipation module 110 with an antistatic effect. The color material layer, antifouling material layer or antistatic material layer also may include nano-material such as nano TiO₂ or SiO₂. Then, the heat dissipation module 110 has a preferred anti-oxidation and dustproof function.

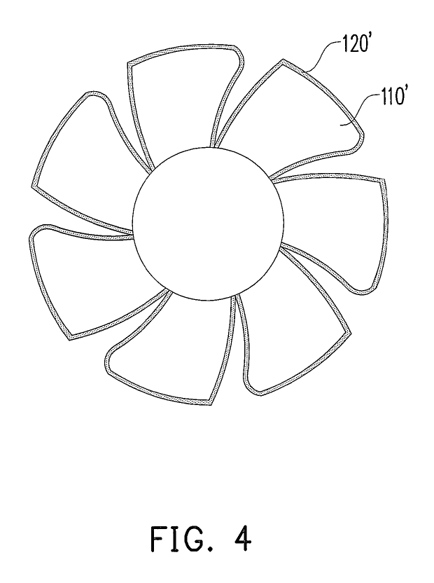

In other embodiment, the heat dissipation module 110′ also may be a heat dissipation fan (FIG. 4 is a schematic diagram showing a heat dissipation module on which a method for treating surface is performed according to another embodiment of the invention). By the method for treating surface of the above embodiment, at least a nano-material layer 120′ having nano-material such as the nano TiO₂ or SiO₂ is formed on the surface of the heat dissipation module 110′. Then, the heat dissipation module 110′ has characteristics of anti-abrasion, anti-dust or antistatic. In the embodiment, an anti-glare plating may be formed on the heat dissipation fan using transparent material to enable the transparent material to have a preferred optical nature and a preferred visual quality. Since the dust is not easily accumulated on the heat dissipation fan and the fan blades having dustproof effect, the rotation of the fan blades is smooth, and the heat dissipation fan has a long lifespan.

To sum up, in the method for treating the surface of a heat dissipation module of the invention, a nano-material layer is formed on the surface of the heat dissipation module to isolate the heat dissipation module from the air. Then, the heat dissipation module does not contact the air or pollution in the environment easily, the metal surface of the heat dissipation module is not oxidized by the air in the environment easily, and the heat dissipation module is not polluted easily. In this way, a heat dissipation module such as a metal heat sink has good heat conduction efficiency, and dust is not accumulated on a heat dissipation module such as a heat dissipation fan easily. The heat dissipation module has a long lifespan.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for treating the surface of a heat dissipation module comprising the steps of:
providing a heat dissipation module; and
forming a nano-material layer at the surface of the heat dissipation module.

2. The method according to claim 1, wherein the method for forming the nano-material layer comprises a plating process.

3. The method according to claim 1, wherein the nano-material layer is formed at the surface of the heat dissipation module in a coating manner.

4. The method according to claim 1, wherein the nano-material layer comprises nano titania powder (TiO₂) or silicon dioxide (SiO₂).

5. The method according to claim 1, further comprising the step of performing a surface leveling process on the heat dissipation module before the nano-material layer is formed at the surface of the heat dissipation module.

6. The method according to claim 5, wherein the surface leveling process comprises an acid washing process.

7. The method according to claim 6, wherein the acid washing solution used in the acid washing process comprises dilute sulphuric acid solution.

8. The method according to claim 5, wherein the surface leveling process comprises a dip plating method.

9. The method according to claim 8, wherein the dip plating solution used in the dip plating method comprises nano TiO₂ or SiO₂ dip plating solution.

10. The method according to claim 1, further comprising the step of forming a nano-material protecting layer on the nano-material layer after the nano-material layer is formed at the surface of the heat dissipation module.

11. The method according to claim 1, further comprising the step of forming a color material layer on the nano-material layer after the nano-material layer is formed at the surface of the heat dissipation module.

12. The method according to claim 11, wherein the color material layer comprises nano TiO₂ or SiO₂.

13. The method according to claim 1, further comprising the step of forming an antifouling material layer on the nano-material layer after the nano-material layer is formed at the surface of the heat dissipation module.

14. The method according to claim 13, wherein the antifouling material layer comprises nano TiO₂ or SiO₂.

15. The method according to claim 1, further comprising the step of forming an antistatic material layer on the nano-material layer after the nano-material layer is formed at the surface of the heat dissipation module.

16. The method according to claim 15, wherein the antistatic material layer comprises nano TiO₂ or SiO₂.

17. The method according to claim 1, wherein the heat dissipation module is an extruded heat sink or a heat dissipation fan.
